(19) United States
(12) Patent Application Publication
(10) Pub. No.: US 2025/0234285 A1
(43) Pub. Date: Jul. 17, 2025

(54) USER EQUIPMENT MOBILITY FOR MULTICAST AND BROADCAST SERVICES

(71) Applicant: Nokia Technologies Oy, Espoo (FI)

(72) Inventors: Guillaume DECARREAU, Munich (DE); Philippe GODIN, Versailles (FR); David NAVRÁTIL, Helsinki (FI); Ugur Baran ELMALI, Munich (DE); Benoist Pierre SEBIRE, Tokyo (JP)

(21) Appl. No.: 18/853,605

(22) PCT Filed: Mar. 6, 2023
(86) PCT No.: PCT/EP2023/055616

§ 371 Date: Oct. 2, 2024

Related U.S. Application Data
(60) Provisional application No. 63/327,208, filed on Apr. 4, 2022.

(51) Int. Cl. H04W 48/20; H04W 76/27; H04W 76/40

(52) U.S. Cl. CPC H04W 48/20; H04W 76/27; H04W 76/40

(57) ABSTRACT

Systems, methods, apparatuses, and computer program products for user equipment (UE) mobility for multicast and broadcast systems (MBS). A method may include receiving, while having an established radio resource control connection with a source network element, multicast and broadcast services session through a point-to-point transmission or point-to-multipoint transmission. The method may also include receiving a radio resource control message indicating target network element information. The method may further include releasing a radio resource control connection and entering radio resource control idle state or inactive state in response to the radio resource control message. In addition, the method may include selecting a target cell according to information received in the radio resource control message. Further, the method may include performing radio communication with a target network element via the target cell, and receiving the multicast and broadcast services session in radio resource control idle state or inactive state.

### CROSS REFERENCE TO RELATED APPLICATION

This application claims priority from U.S. provisional patent application No. 63/327,208 filed on Apr. 4, 2022. The contents of this earlier filed application are hereby incorporated by reference in their entirety.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for user equipment (UE) mobility for multicast and broadcast services (MBS).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include receiving, while having an established radio resource control connection with a source network element, multicast and broadcast services session through a point-to-point transmission or point-to-multipoint transmission. The method may also include receiving a radio resource control message indicating target network element information. The method may further include releasing a radio resource control connection and entering radio resource control idle state or inactive state in response to the radio resource control message. In addition, the method may include selecting a target cell according to information received in the radio resource control message. Further, the method may include performing radio communication with the target cell. In addition, the method may include receiving the multicast and broadcast services session in the target cell in inactive state or idle state.

Other example embodiments may be directed to an apparatus. The apparatus may include at least one processor and at least one memory including computer program code. The at least one memory and computer program code may also be configured to, with the at least one processor, cause the apparatus at least to receive, while having an established radio resource control connection with a source network element, multicast and broadcast services session through a point-to-point transmission or point-to-multipoint transmission. The apparatus may also be caused to receive a radio resource control message indicating target network element information. The apparatus may further be caused to release a radio resource control connection and entering radio resource control idle state or inactive state in response to the radio resource control message. In addition, the apparatus may be caused to selecting a target cell according to information received in the radio resource control message. Further, the apparatus may be caused to perform radio communication with the target cell. In addition, the apparatus may be caused to receive the multicast and broadcast services session in the target cell in inactive state or idle state.

Other example embodiments may be directed to an apparatus. The apparatus may include means for receiving, while having an established radio resource control connection with a source network element, multicast and broadcast services session through a point-to-point transmission or point-to-multipoint transmission. The apparatus may also include means for receiving a radio resource control message indicating target network element information. The apparatus may further include means for releasing a radio resource control connection and entering radio resource control idle state or inactive state in response to the radio resource control message. In addition, the apparatus may include means for selecting a target cell according to information received in the radio resource control message. Further, the apparatus may include means for performing radio communication with the target cell. In addition, the apparatus may include means for receiving the multicast and broadcast services session in the target cell in inactive state or idle state.

In accordance with other example embodiments, a non-transitory computer readable medium may be encoded with instructions that may, when executed in hardware, perform a method. The method may include receiving, while having an established radio resource control connection with a source network element, multicast and broadcast services session through a point-to-point transmission or point-to-multipoint transmission. The method may also include receiving a radio resource control message indicating target network element information. The method may further include releasing a radio resource control connection and entering radio resource control idle state or inactive state in response to the radio resource control message. In addition, the method may include selecting a target cell according to information received in the radio resource control message. Further, the method may include performing radio communication with the target cell. In addition, the method may include receiving the multicast and broadcast services session in the target cell in inactive state or idle state.

Other example embodiments may be directed to a computer program product that performs a method. The method may include receiving, while having an established radio resource control connection with a source network element, multicast and broadcast services session through a point-to-point transmission or point-to-multipoint transmission. The method may also include receiving a radio resource control message indicating target network element information. The method may further include releasing a radio resource control connection and entering radio resource control idle state or inactive state in response to the radio resource control message. In addition, the method may include selecting a target cell according to information received in the radio resource control message. Further, the method may include performing radio communication with the target cell. In addition, the method may include receiving the multicast and broadcast services session in the target cell in inactive state or idle state.

Other example embodiments may be directed to an apparatus that may include circuitry configured to receive, while having an established radio resource control connection with a source network element, multicast and broadcast services session through a point-to-point transmission or point-to-multipoint transmission. The apparatus may also include circuitry configured to receive a radio resource control message indicating target network element information. The apparatus may further include circuitry configured to release a radio resource control connection and entering radio resource control idle state or inactive state in response to the radio resource control message. In addition, the apparatus may include circuitry configured to select a target cell according to information received in the radio resource control message. Further, the apparatus may include circuitry configured to perform radio communication with the target cell. In addition, the apparatus may include circuitry configured to receive the multicast and broadcast services session in the target cell in inactive state or idle state.

Certain example embodiments may be directed to a method. The method may include transmitting a handover request message to a target network element. The method may also include receiving a handover request response message comprising network communication information. The method may further include transmitting a radio resource control message to the user equipment indicating target network element information.

Other example embodiments may be directed to an apparatus. The apparatus may include at least one processor and at least one memory including computer program code. The at least one memory and computer program code may be configured to, with the at least one processor, cause the apparatus at least to transmit a handover request message to a target network element. The apparatus may also be caused to receive a handover request response message comprising network communication information. The apparatus may further be caused to transmit a radio resource control message to the user equipment indicating target network element information.

Other example embodiments may be directed to an apparatus. The apparatus may include means for transmitting a handover request message to a target network element. The apparatus may also include means for receiving a handover request response message comprising network communication information. The apparatus may further include means for transmitting a radio resource control message to the user equipment indicating target network element information.

In accordance with other example embodiments, a non-transitory computer readable medium may be encoded with instructions that may, when executed in hardware, perform a method. The method may include transmitting a handover request message to a target network element. The method may also include receiving a handover request response message comprising network communication information. The method may further include transmitting a radio resource control message to the user equipment indicating target network element information.

Other example embodiments may be directed to a computer program product that performs a method. The method may include transmitting a handover request message to a target network element. The method may also include receiving a handover request response message comprising network communication information. The method may further include transmitting a radio resource control message to the user equipment indicating target network element information.

Other example embodiments may be directed to an apparatus that may include circuitry configured to transmit a handover request message to a target network element. The apparatus may also include circuitry configured to receive a handover request response message comprising network communication information. The apparatus may further include circuitry configured to transmit a radio resource control message to the user equipment indicating target network element information.

Certain example embodiments may be directed to a method. The method may include receiving a handover request message from a source network element. The method may also include transmitting, in response to the handover request message, a handover request response message comprising network communication information to the source network element. The method may further include transmitting, with point-to-multi point transmission, multicast and broadcast services session information to a user equipment in radio resource control idle state or inactive state.

Other example embodiments may be directed to an apparatus. The apparatus may include at least one processor and at least one memory including computer program code. The at least one memory and computer program code may be configured to, with the at least one processor, cause the apparatus at least to receive a handover request message from a source network element. The apparatus may also be caused to transmit, in response to the handover request message, a handover request response message comprising network communication information to the source network element. The apparatus may further be caused to transmit, with point-to-multi point transmission, multicast and broadcast services session information to a user equipment in radio resource control idle state or inactive state.

Other example embodiments may be directed to an apparatus. The apparatus may include means for receiving a handover request message from a source network element. The apparatus may also include means for transmitting, in response to the handover request message, a handover request response message comprising network communication information to the source network element. The apparatus may further include means for transmitting, with point-to-multi point transmission, multicast and broadcast services session information to a user equipment in radio resource control idle state or inactive state.

In accordance with other example embodiments, a non-transitory computer readable medium may be encoded with instructions that may, when executed in hardware, perform a method. The method may include receiving a handover request message from a source network element. The method may also include transmitting, in response to the handover request message, a handover request response message comprising network communication information to the source network element. The method may further include transmitting, with point-to-multi point transmission, multicast and broadcast services session information to a user equipment in radio resource control idle state or inactive state.

Other example embodiments may be directed to a computer program product that performs a method. The method may include receiving a handover request message from a source network element. The method may also include transmitting, in response to the handover request message, a handover request response message comprising network communication information to the source network element. The method may further include transmitting, with point-to-multi point transmission, multicast and broadcast services session information to a user equipment in radio resource control idle state or inactive state.

Other example embodiments may be directed to an apparatus that may include circuitry configured to receive a handover request message from a source network element. The apparatus may also include circuitry configured to transmit, in response to the handover request message, a handover request response message comprising network communication information to the source network element. The apparatus may further include circuitry configured to transmit, with point-to-multi point transmission, multicast and broadcast services session information to a user equipment in radio resource control idle state or inactive state.

### BRIEF DESCRIPTION OF THE DRAWINGS

For proper understanding of example embodiments, reference should be made to the accompanying drawings, wherein:

FIG. 1 illustrates an example architecture of the protocol layers for delivery mode 1 (DM-1).

FIG. 2 illustrates an example architecture of the protocol layers for delivery mode 2 (DM-2).

FIG. 3 illustrates an example signal flow of a conditional handover (CHO).

FIG. 4 illustrates an example signal diagram of an exemplary problem scenario.

FIG. 5 illustrates an example signal diagram with a baseline handover (HO), according to certain example embodiments.

FIG. 6 illustrates an example signal diagram with a conditional handover (CHO), according to certain example embodiments.

FIG. 7 illustrates another example signal diagram with a baseline HO, according to certain example embodiments.

FIG. 8 illustrates another example signal diagram with a CHO, according to certain example embodiments.

FIG. 9 illustrates an example signal diagram based on a configuration update between gNBs without HO, according to certain example embodiments.

FIG. 10 illustrates an example flow diagram of a method, according to certain example embodiments.

FIG. 11 illustrates an example flow diagram of another method, according to certain example embodiments.

FIG. 12 illustrates an example flow diagram of a further method, according to certain example embodiments.

FIG. 13 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for user equipment (UE) mobility for multicast and broadcast systems.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably. Additionally, the term “gNB” may be an example of a “node”.

3^{rd} Generation Partnership Project (3GPP) supports multicast and broadcast services (MBS). According to 3GPP, point-to-multipoint (PTM) transmissions may be targeted to efficiently provision MBS to multiple users by using the same radio framework as unicast transmission. UEs in RRC_CONNECTED state may receive a delivery mode 1 (i.e., multicast), and UEs in all RRC states may receive a delivery mode 2 (i.e., broadcast). Delivery mode 1 (DM-1) may provide transport blocks (TBs) both in a PTM or a point-to-point (PTP) manner to the UE. In some instances, hybrid automatic repeat request (HARQ) feedback may be used for link adaptation in DM-1, whereas delivery mode 2 (DM-2) may provide transport blocks (TBs) in a PTM manner without HARQ feedback.

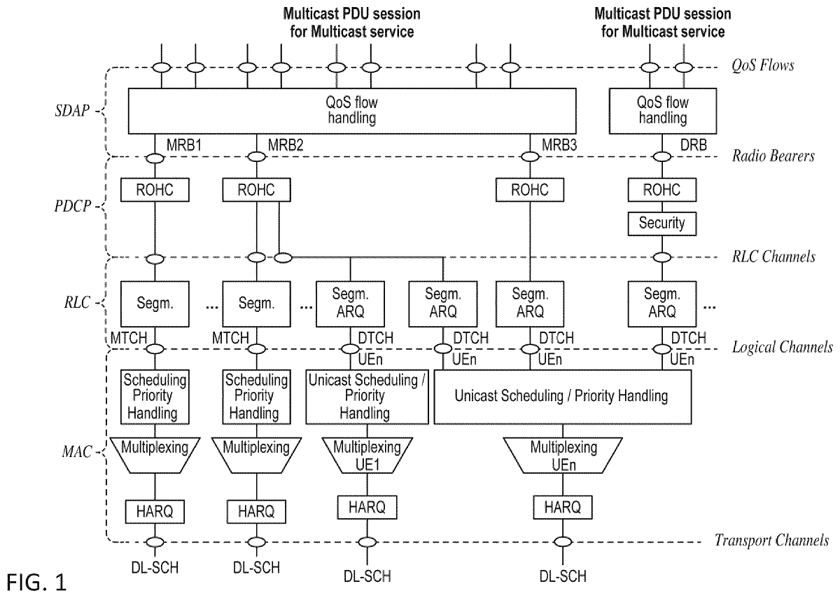

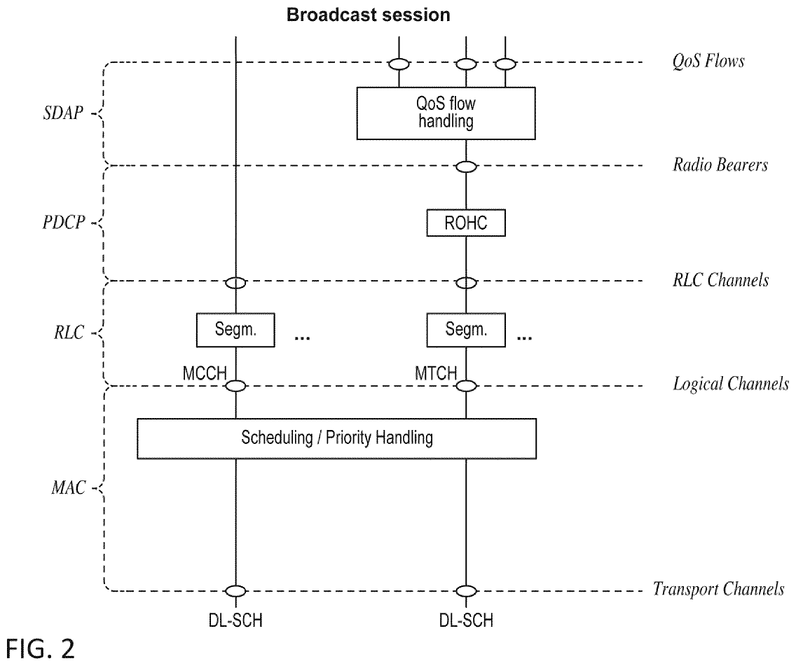

FIG. 1 illustrates an example architecture of the protocol layers for DM-1, and FIG. 2 illustrates an example architecture of the protocol layers for DM-2. In some cases, the terms “multicast” and “broadcast” may have different meanings in terms of the core network and radio access network (RAN) perspectives. In certain example embodiments, the term “broadcast” may relate to the transmissions made in DM-2, whereas “multicast” may relate to the transmissions made in DM-1 (i.e., from the RAN perspective). On the other hand, from the core network perspective, multicast may be the service for which the UEs send requests for joining, and broadcast may be the service for which the UEs do not send any requests for joining. Certain example embodiments described herein may utilize multicast from the core network perspective.

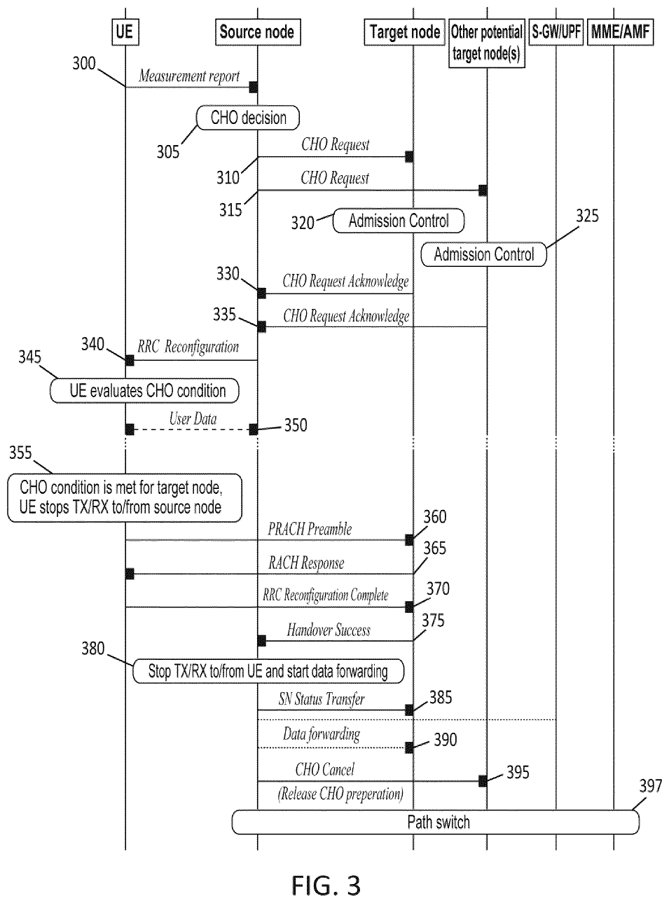

According to 3GPP, conditional handover (CHO) may be introduced to minimize radio link failures (RLFs) and handover failures (HOFs) resulting from timing issues along with mobility-triggered cell changes. FIG. 3 illustrates an example signal diagram of a CHO. At 300, the UE may send a measurement report to the source node. At 305, the source node may make a CHO decision based on the measurement report. At 310 and 315, the source node may send a CHO request to the target node and other potential target node(s), respectively. At 320 and 325, the target node and other potential target node(s) may perform an admission control procedure in response to the request. At 330 and 335, the target node and other potential target node(s) may send a CHO request acknowledgment message to the source node. In response, the source node may, at 340, send a radio resource control (RRC) reconfiguration to the UE, and the UE may, at 345, evaluate the CHO condition. At 350, user data may be exchanged between the UE and the source node. Further, at 355, the UE may determine that the CHO condition has been met for the target node, and stop Tx/Rx to/from the source node.

As further illustrated in FIG. 3, at 360, the UE may send a physical random access channel (PRACH) preamble to the target node and, at 365, the target node may send a random access channel (RACH) response to the UE. After receiving the RACH response, the UE may, at 670, send a RRC reconfiguration complete message to the target node. At 375, the target node may send a handover (HO) success message to the source node indicating that handover from the source node to the target node was successful. At 380, the source node may stop Tx/Rx to/from the UE, and start data forwarding to the target node. At 385, the source node may send an SN status transfer message to the target node, and at 390, may begin data forwarding to the target node. At 395, the source node may cancel the CHO at other potential target nodes. At 397, a path switch procedure may be performed between the source node and the target node (i.e. the node that received the RRC reconfiguration complete message), session management function (SMF), serving gateway (S-GW)/user plane function (UPF), and mobility management entity (MME)/access management function (AMF). In FIG. 3 the AMF may, for each protocol data unit (PDU) session, transparently transfer the path switch request transfer information element (IE) to the SMF associated with the concerned PDU session.

The existing MBS framework may encounter certain challenges including, for example, wasting resources (i.e., signaling overhead), as some extra dedicated signaling may be needed between the target cell and the UE for handover, and for RRC state transition. Moreover, unnecessary delay and energy consumption may be introduced. Such challenges may occur when the UE receives a multicast session that can be served in a source cell using PTP or PTM in RRC_CONNECTED state (DM-1) for the multicast session. Here, it may be assumed that such a UE is handed over to a target cell using a handover (HO) procedure. If the target cell decides to use in DM-2 to serve the UE in RRC_IDLE/INACTIVE state for the multicast session (i.e., in a case where there is an ongoing DM-2 for that multicast session in the target), the target cell may send another RRC message (e.g. RRC release message) to the UE to change its state from RRC_CONNECTED to RRC_IDLE/RRC_INACTIVE after the HO is completed, and the UE starts initially with RRC_CONNECTED state.

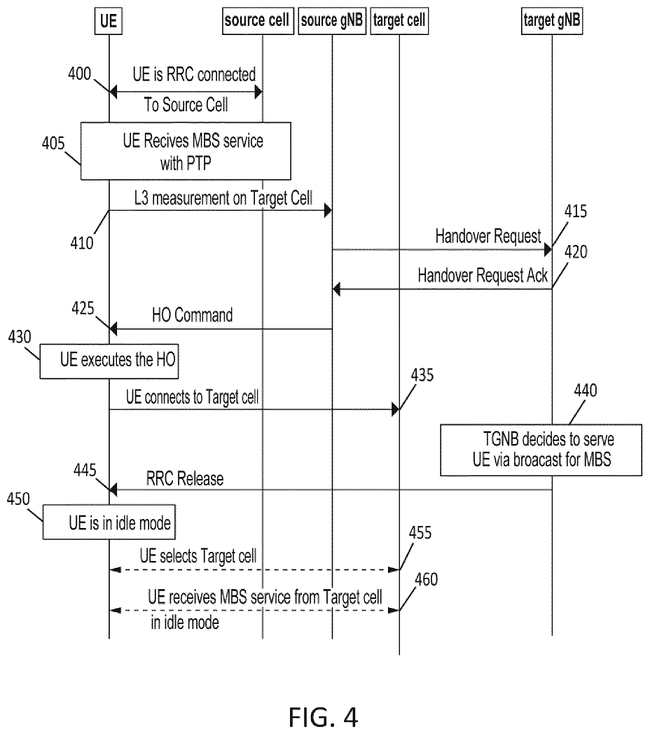

FIG. 4 illustrates an example signal diagram of an exemplary problem scenario. At 400, the UE may be RRC connected to the source cell. At 405, the UE may receive MBS session with PTP. At 410, the UE may send L3 measurements on the target cell to the source gNB. In response, at 415, the source gNB may send a HO request to the target gNB, and at 420, the target gNB may send a HO request acknowledgement (ACK) to the source gNB. At 425, the source gNB may send a HO command to the UE, and at 430, the UE may execute the HO command. Once the HO command has been executed, at 435, the UE may connect to the target cell. At 440, the target gNB may decide to serve the UE via broadcast for MBS. At 445, the target gNB may send a RRC release message to the UE, after which the UE releases the RRC connection to the target cell. At 450, the UE may be in idle mode, and at 455, the UE may select the target cell. While in idle or inactive state, the UE may, at 460, receive MBS service from the target cell.

As discussed herein, certain example embodiments may provide solutions for addressing the problems and challenges described above in the existing MBS framework. For instance, when both the target and the source gNBs support 3GPP Rel-18, when sending the (C-)HO request to the target gNB, the source gNB may indicate that the UE is served for MBS session in RRC_CONNECTED state using an MBS radio bearer (MRB). The MRB may be configured with PTP leg only, PTM leg only or PTP and PTM legs. In its reply, the target gNB may indicate that for this session, it will use DM-2 in IDLE/INACTIVE state.

According to certain example embodiments, in a baseline HO scenario, the target gNB may send the aforementioned information (i.e., the indication from the source gNB that the UE is served for MBS session in RRC_CONNECTED state using an MRB) with a HO request preparation failure message. In response, the source gNB may release the UE's RRC connection, and may indicate the target frequency and/or target cell ID (along with further information to receive DM-2 transmission for the MBS session provided by the target in the handover request preparation failure message). Thus, the HO request preparation failure message may indicate one or more candidate target cell IDs with the further information (i.e., MBS configuration for DM-2) provided per cell or a set of cells, and after having received the RRC release message the UE can receive the MBS session while being in RRC IDLE/INACTIVE state. In other example embodiments, when the HO is a CHO, the target gNB may reply with a HO request acknowledgment (ACK) message, and include in the RRC reconfiguration message comprising an order to go to IDLE/INACTIVE state upon execution of the condition. In some other embodiments, the target gNB may reply with a HO request acknowledgment (ACK) message, and include in the RRC release message comprising an order to go to IDLE/INACTIVE state upon execution of the condition. Additionally, the HO request acknowledgment message may include information to receive broadcast service.

In certain example embodiments, when the source gNB supports 3GPP Rel-17, and the target gNB supports 3GPP Rel-18, the mechanism may be transparent to the source gNB. As such, the source gNB may not indicate to the target gNB in an HO request message that the UE is served at the source gNB for MBS session in RRC_CONNECTED state, e.g. using DM-1. Instead, the target gNB may infer from the provided MBS information that the UE is served at the source gNB for MBS session using DM-1. In other example embodiments, the target gNB may reply with a HO request ACK message, which may include the RRC reconfiguration message that comprises an order to go to IDLE/INACTIVE state (upon execution of the condition in a CHO scenario). In other example embodiments, the target gNB may reply with a HO request ACK message, which may include the RRC release message that comprises an order to go to IDLE/INACTIVE state (upon execution of the condition in a CHO scenario). The handover request ACK message may also include additional information to receive MBS session.

According to certain example embodiments, in a CHO, when both the target and the source gNBs support 3GPP Rel-18, and in a baseline HO, when the source gNB supports 3GPP Rel-17 and the target gNB supports 3GPP Rel-18, the core network changes may be needed when the UE is to be directed to the RRC IDLE state. In particular, the target gNB may not have the UE context, signaling connection to the AMF, and the N3 transport at the end of the HO procedure. Thus, the target gNB may act as if it has accepted the HO, and may send an indication of HO to IDLE in the path switch request message to the AMF. Upon receiving the indication of HO to IDLE, in this example embodiment, the AMF knows no signaling connection and no new N3 tunnels are to be established. Furthermore, the AMF may transfer the path switch request message or its part to the SMF including the information indicative of HO to IDLE. The SMF may be caused to release the N3 tunnel used with the source gNB.

According to other example embodiments, in a CHO, when both the target and source gNBs support 3GPP Rel-18, and when the gNB supports 3GPP Rel-17 and target gNB supports 3GPP Rel-18, the target gNB may not know whether the CHO configuration had been executed by the UE. Thus, the target gNB cannot know when to send the UE context release message to the source gNB. Accordingly, the RRC reconfiguration that was sent by the target gNB and forwarded to the UE via the source gNB may include dedicated resources (e.g., a dedicated RACH preamble). Thus, after the UE starts receiving the broadcast service from the target cell in the IDLE/INACTIVE state, the UE may utilize the dedicated resource. Upon reception of this transmission, the target gNB may convey the UE context release message to the source gNB. This may be in HO Success message.

In certain example embodiments, an alternative to the above-described solutions may be provided. For instance, contrary to the above-described solutions, certain example embodiments may focus on a solution that does not involve HO request toward the target gNB. Instead, the gNBs may exchange information about their serving cells with neighbor gNBs that provide MBS sessions. Based on the information received from the neighbor gNBs, if the source gNB decides to hand the UE over to one of the neighbor gNBs that provided the information, the source gNB may, instead of performing the HO, release the UE to IDLE/INACTIVE state and provide necessary configuration to receive the MBS session in one or more cells of the target gNBs.

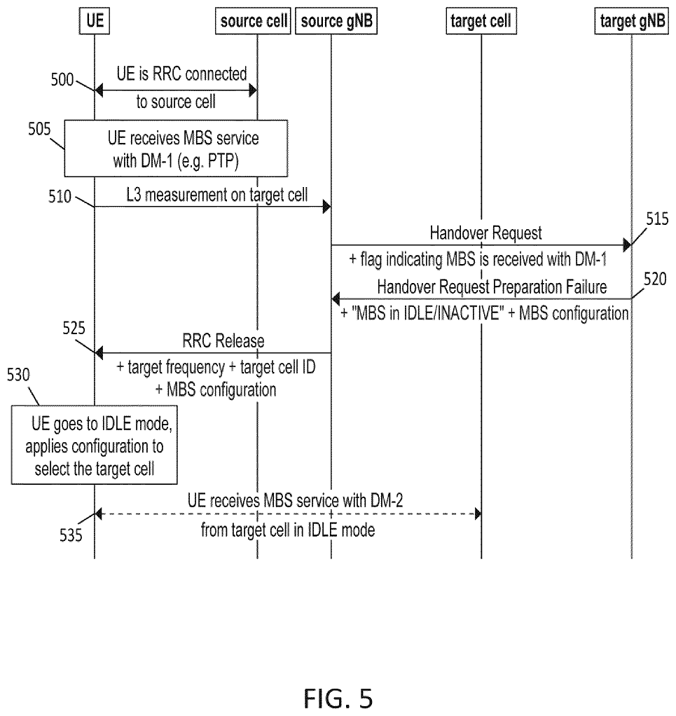

FIG. 5 illustrates an example signal diagram with a baseline HO, according to certain example embodiments. At 500, the UE may be RRC connected to the source cell. At 505, the UE may receive MBS session with DM-1 through PTP and/or PTM (i.e., MBS radio bearer (MRB) with PTP leg only, PTM leg only or PTP and PTM legs). At 510, the UE may obtain and send L3 measurements of the target cell to the source gNB, indicating that the quality (e.g., reference signal received power or reference signal received quality) of the target cell is better than that of the serving cell. At 515, the source gNB may send a handover request message to the target gNB. According to certain example embodiments, the handover request message may indicate, via a flag, that the UE is receiving MBS session with DM-1. At 520, in response to the handover request message, the target gNB may reply to the source gNB with a handover request preparation failure message. According to certain example embodiments, the handover request preparation failure message may indicate in at least one of an Xn application protocol (XnAP) cause value or in a new XnAP information element that MBS session in the target cell is served using DM-2 and/or the MBS configuration for DM-2 at the target cell (e.g., MBS PTM traffic channel (MTCH) configuration).

At 525, the source gNB may send a RRC release message with redirection information comprising the target frequency and/or target cell ID, along with the MBS configuration at the target cell. The RRC release message may release or suspend an RRC connection upon the reception of the message. At 530, the UE may release its RRC connection and enter IDLE/INACTIVE state. The UE may also select the target cell according to the redirection information received in the RRC release message from the source gNB. At 535, the UE may use the MBS information received in the RRC release message to receive the MBS session through broadcast in the target cell. For instance, in certain example embodiments, the UE may receive the MBS session with DM-2 from the target cell in IDLE state.

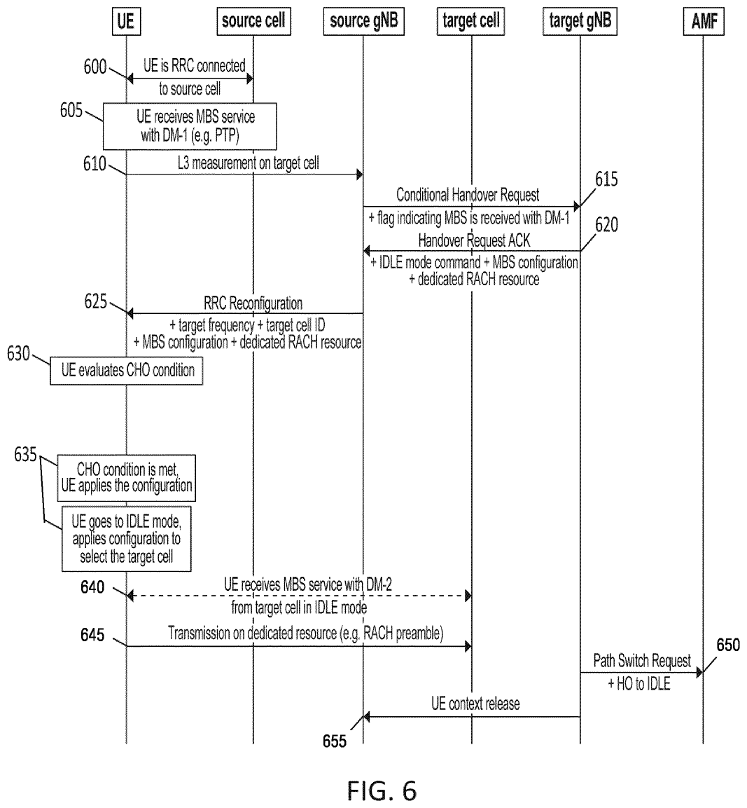

FIG. 6 illustrates an example signal diagram with CHO, according to certain example embodiments. At 600, the UE may be RRC connected to the source cell. At 605, the UE may receive MBS session with DM-1 through PTP and/or PTM (i.e., MRB). At 610, the UE may obtain and send L3 measurements of the target cell to the source gNB, indicating that the quality (e.g., reference signal received power or reference signal received quality) of the target cell is better than that of the serving cell. At 615, the source gNB may send a CHO request message to the target gNB. According to certain example embodiments, the CHO request message may indicate, via a flag or an XnAP information element, that the UE is receiving MBS session with DM-1. At 620, the target gNB may reply with a HO request ACK message. According to certain example embodiments, the HO request ACK message may include an IDLE/INACTIVE state command for the UE to go to IDLE/INACTIVE state upon execution of the condition, and may include the MBS configuration at the target cell (e.g., MTCH configuration). The HO request ACK message may also include an additional resource including, for example, a RACH preamble or RACH occasion dedicated for the UE to signal to the target gNB that the UE had applied the CHO configuration.

At 625, the source gNB may send a RRC reconfiguration message with redirection information comprising the target frequency and/or target cell ID, along with the MBS configuration at the target cell, and the dedicated RACH preamble. At 630, the UE may evaluate the CHO condition. At 635, when the CHO condition is satisfied, the UE may apply the configuration. After the condition is satisfied, the UE may enter IDLE state, and apply the redirection information to select the target cell. At 640, the UE may apply the MBS information received in the RRC reconfiguration message to receive the MBS session through broadcast in the target cell. For instance, in certain example embodiments, the UE may receive the MBS session with DM-2 from the target cell in IDLE mode. At 645, the UE may perform radio transmission on the dedicated resource (e.g., RACH preamble). Afterwards, at 650, the gNB may send a path switch request to the AMF. According to certain example embodiments, the path switch request may include the information indicative of HO to IDLE/INACTIVE state. As such, no signaling connection and no new tunnels are to be established. Furthermore, the AMF may transfer the path switch request message or its part to the SMF including the information indicative of HO to IDLE. The SMF may be caused to release the tunnel (N3 tunnel) used with the source gNB. According to some example embodiments, operations 640 and 645 may be performed in reverse order. At 660, the target gNB may send UE context release to the source gNB which can be an XnAP HO Success message.

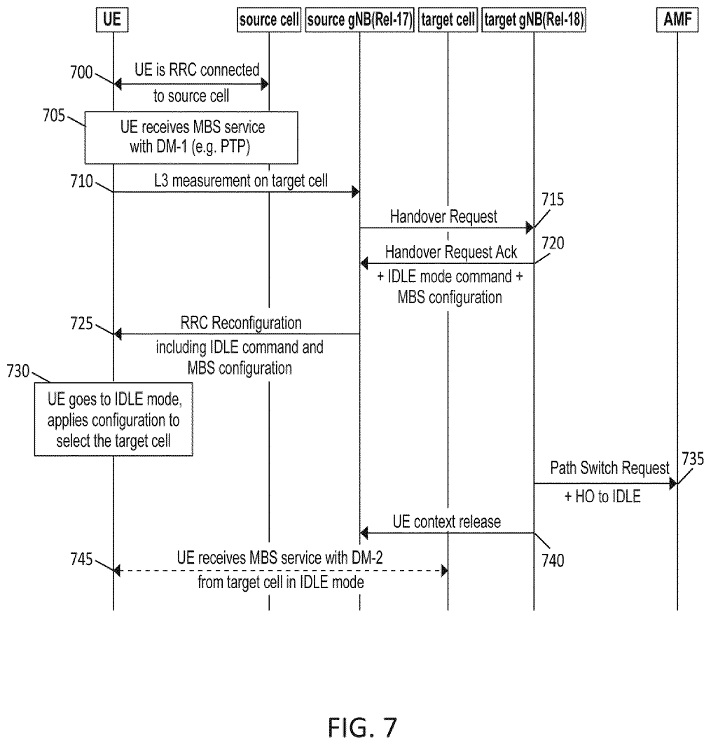

FIG. 7 illustrates another example signal diagram with a baseline HO, according to certain example embodiments. At 700, the UE may be RRC connected to the source cell. At 705, the UE may receive MBS session with DM-1 through PTP and/or PTM (i.e., MRB). At 710, the UE may obtain and send L3 measurements of the target cell to the source gNB, indicating that the quality (e.g., reference signal received power or reference signal received quality) of the target cell is better than that of the serving cell. Further, at 715, the source gNB may send a HO request message to the target gNB. At 720, the target gNB may reply with a HO request ACK message. According to certain example embodiments, the HO request ACK message may include RRC reconfiguration including the command to the UE to go to IDLE/INACTIVE state, and the necessary configurations to select the target cell, along with the configurations to receive MBS session with DM-2 in the target cell. At 725, the source gNB may forward the RRC reconfiguration to the UE. According to certain example embodiments, the RRC reconfiguration may include the IDLE/INACTIVE command and the MBS configuration received from the target gNB. At 730, the UE may release its RRC connection and enter IDLE/INACTIVE state. The UE may also select the target cell according to the information received in the RRC reconfiguration message from the source gNB.

At 735, the target gNB may send a path switch request message to the AMF. According to certain example embodiments, the path switch request message may include the information indicative of HO to IDLE state. As such, no signaling connection, and no new tunnels are to be established. Furthermore, the AMF may transfer the path switch request message or its part to the SMF including the information indicative of HO to IDLE. The SMF may be caused to release the N3 tunnel used with the source gNB. At 740, the target gNB may send UE context release to the source gNB, which informs the source gNB about the success of the HO. At 745, the UE may select the target cell according to the information received in the RRC reconfiguration message. According to certain example embodiments, the UE may use the MBS information received in the RRC reconfiguration message to receive the MBS session through broadcast in the target cell. For instance, in certain example embodiments, the UE may receive the MBS session with DM-2 from the target cell in IDLE mode.

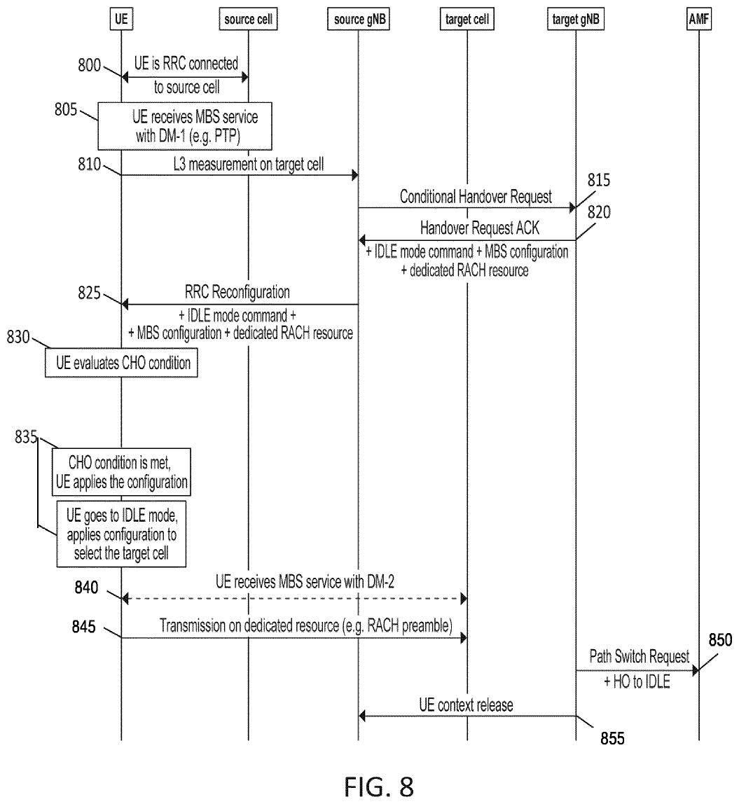

FIG. 8 illustrates another example signal diagram with CHO, according to certain example embodiments. At 800, the UE may be RRC connected to the source cell. At 805, the UE may receive an MBS session with DM-1 through PTP and/or PTM (i.e., MRB). At 810, the UE may send L3 measurements of the target cell to the source gNB, indicating that the quality (e.g., reference signal received power or reference signal received quality) of the target cell is better than that of the serving cell. At 815, the source gNB may send a CHO request message to the target gNB. At 820, the target gNB may reply with a HO request ACK message. According to certain example embodiments, the HO request ACK message may include an IDLE/INACTIVE command for the UE to go to IDLE/INACTIVE state upon execution of the condition, and the MBS configuration at the target cell (e.g., MTCH configuration). The HO request ACK message may also include an additional resource including, for example, a RACH preamble or RACH occasion dedicated for the UE to signal to the target gNB that the UE had applied the CHO configuration.

At 825, the source gNB may send a RRC reconfiguration message with redirection information comprising one or more target cell IDs and/or target frequency, along with the MBS configuration at the target cell, and the dedicated RACH preamble. In certain example embodiments, when there is more than one target cell ID, the MBS configuration and RACH preamble may be provided per cell or set of cells. At 830, the UE may evaluate the CHO condition and, at 835, when the CHO condition is satisfied, the UE may apply the configuration. After the condition is satisfied, the UE may enter IDLE state, and apply the redirection information to select the target cell. At 840, the UE may use the MBS information received in the RRC reconfiguration message to receive the MBS session through broadcast in the target cell. For instance, in certain example embodiments, the UE may receive the MBS session with DM-2 from the target cell in IDLE state. At 845, the UE may perform radio transmission on the dedicated resource (e.g., RACH preamble). At 850, the gNB may send a path switch request to the AMF. According to certain example embodiments, the path switch request may include the information indicative of HO to IDLE/INACTIVE state. As such, no signaling connection and no new tunnels are to be established. Furthermore, the AMF may transfer the path switch request message or its part to the SMF including the information indicative of HO to IDLE. The SMF may be caused to release the N3 tunnel used with the source gNB. According to some example embodiments, operations 840 and 845 may be performed in reverse order. At 855, the target gNB may transmit UE context release to the source gNB which can be an XnAP HO Success message.

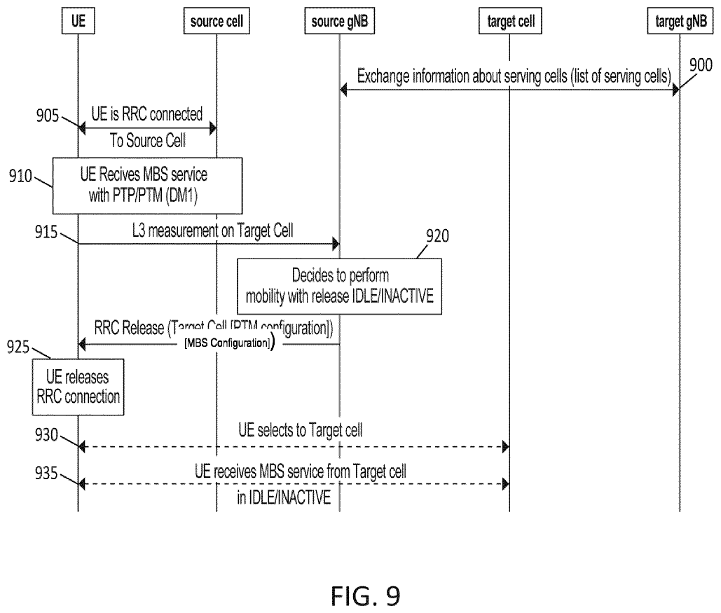

FIG. 9 illustrates an example signal diagram based on a configuration update between gNBs without HO, according to certain example embodiments. According to other example embodiments, the solution may not involve a HO request toward the target gNB. For instance, requesting a HO for every UE moving towards a cell that provides an MBS session to UEs in IDLE/INACTIVE state may be unnecessary. Instead, the gNBs may exchange information beforehand about their serving cells. In certain example embodiments, the information may include information for each cell, and may include at least identity of the MBS session (MBS session ID), and whether the session is being served to UEs in IDLE/INACTIVE state. In other example embodiments, the gNBs may exchange configuration information needed for the reception of the multicast session in IDLE/INACTIVE state (e.g., MTCH configuration).

At 900, the source gNB and the target gNB may exchange information. In some example embodiments, the exchange of information between the source and target gNBs may be performed using XnAP setup/response, XnAP NG-RAN node configuration update/update ACK, and others. In certain example embodiments, the information may relate to serving cells including per serving cell/beam, and per MBS session. For instance, the information may include session identity (e.g., MBS session ID), information on whether the MBS session is delivered to UEs in IDLE/INACTIVE state, and/or RRC configuration used in the cell for UEs in IDLE/INACTIVE state.

At 905, UE may be RRC connected to the source cell. At 910, the UE may connect to the network and join a multicast MBS session. For instance, the source gNB may configure the UE for reception of a multicast MBS session with PTP/PTM (DM-1) in an RRC CONNECTED state. At 915, the UE may send L3 measurements of the target cell to the source gNB, indicating that the quality (e.g., reference signal received power or reference signal received quality) of the target cell is better than that of the serving cell. At 920, based on the information previously received from the target gNB, the source gNB may decide to perform mobility to target gNB using RRC connection release, which releases the UE to an IDLE/INACTIVE state.

At 925, the source gNB may send an RRC release message to the UE indicating one or more target cells that the UE should attempt to reselect to. If the source gNB received MBS configuration for UEs in IDLE/INACTIVE state for this cell from the target gNB, then this information may be provided to the UE. In doing so, it may be possible to minimize the time the UE is able to receive the multicast MBS session in the target cell as the UE may not be required to acquire a system information block (e.g. SIBx) and/or multicast control channels (MCCH) in the target cell before receiving the corresponding MTCH. At 925, the UE may release the RRC connection and, at 930, the UE may perform cell reselection towards the target cell indicated in operation 925. At 935, the UE may receive a multicast MBS session (MBS service) from the target cell in the IDLE/INACTIVE state.

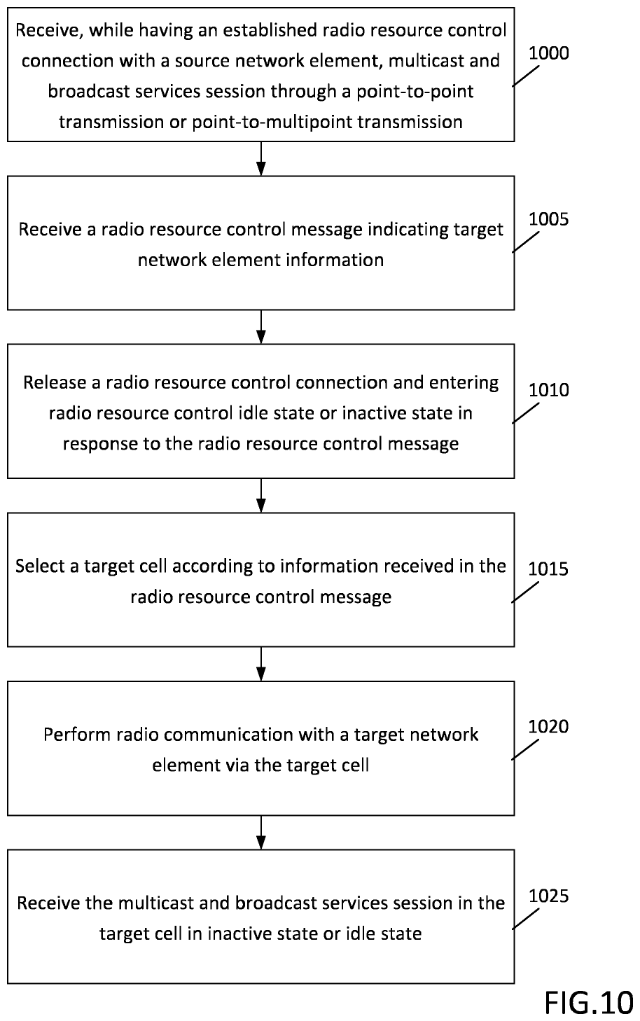

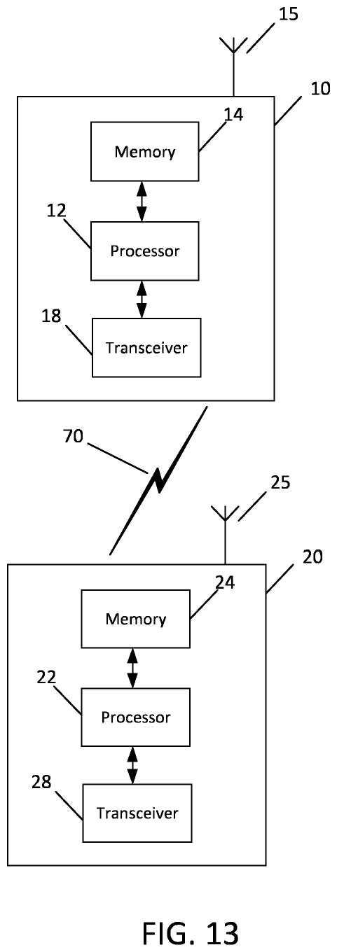

FIG. 10 illustrates an example flow diagram of a method, according to certain example embodiments. In an example embodiment, the method of FIG. 10 may be performed by a network entity, or a group of multiple network elements in a 3GPP system, such as LTE or 5G-NR. For instance, in an example embodiment, the method of FIG. 10 may be performed by a UE or device similar to one of apparatuses 10 or 20 illustrated in FIG. 13.

According to certain example embodiments, the method of FIG. 10 may include, at 1000, receiving, while having an established radio resource control connection with a source network element, multicast and broadcast services session through a point-to-point transmission or point-to-multipoint transmission. The method may also include, at 1005, receiving a radio resource control message indicating target network element information. The method may further include, at 1010, releasing a radio resource control connection and entering radio resource control idle state or inactive state in response to the radio resource control message. In addition, the method may include, at 1015, selecting a target cell according to information received in the radio resource control message. Further, the method may include, at 1020, performing radio communication with the target cell. Further, the method may include, at 1025, receiving the MBS session in radio resource control idle state or inactive state.

According to certain example embodiments, the radio resource control message may be a radio resource control reconfiguration message or a radio resource control release message. According to further example embodiments, the target network element information may include one or more of a target cell frequency, a target cell identifier, and a multicast and broadcast services session configuration at the target cell. According to some example embodiments, the target network element information may include an idle state command, and a multicast and broadcast services session configuration at the target cell. According to further example embodiments, the target network element information may further include a dedicated random access channel resource.

In certain example embodiments, the method may further include using the multicast and broadcast services session configuration to receive a point-to-multipoint transmission of multicast and broadcast services session in idle state or inactive state in the target cell. In some example embodiments, the radio communication may be performed on a dedicated resource. In other example embodiments, the dedicated resource may be a radio access channel preamble.

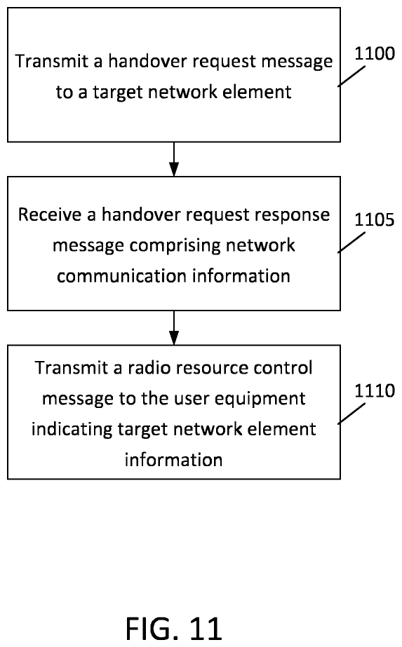

FIG. 11 illustrates an example of a flow diagram of another method, according to certain example embodiments. In an example embodiment, the method of FIG. 11 may be performed by a network entity, or a group of multiple network elements in a 3GPP system, such as LTE or 5G-NR. For instance, in an example embodiment, the method of FIG. 11 may be performed by a network or gNB similar to one of apparatuses 10 or 20 illustrated in FIG. 13.

According to certain example embodiments, the method of FIG. 11 may include, at 1100, transmitting a handover request message to a target network element. The method may also include, at 1105, receiving a handover request response message comprising network communication information. The method may further include, at 1110, transmitting a radio resource control message to the user equipment indicating target network element information.

According to certain example embodiments, the handover request message may include a flag or an information element indicating that a user equipment is receiving point-to-point and/or point-to-multipoint transmission of a multicast and broadcast services session in a radio resource control connected state. According to some example embodiments, the handover request response may be a handover request preparation failure message. According to other example embodiments, the network communication information may include at least one of an indication that the multicast and broadcast services session in a target cell is served using point-to-multipoint transmission to user equipment in an idle or inactive delivery state, and a multicast and broadcast services session configuration. In other example embodiments, the radio resource control message may be a radio resource control release message. In certain example embodiments, the handover request response may be a handover request acknowledgment message. In some example embodiments, the handover request acknowledgement message may include at least one of a command to a user equipment to go to radio resource control idle state or inactive state, a multicast and broadcast services session configuration, and a dedicated random access channel resource. In further example embodiments, the radio resource control message may be a radio resource control reconfiguration message or a radio resource control release message. In other example embodiments, the handover request response may be an Xn Application Protocol handover request acknowledgement message. In further example embodiments, the network communication information may include a command to a user equipment to go to radio resource control idle state or inactive state, and a multicast and broadcast services session configuration at the target cell.

According to certain example embodiments, the target network element information may include a target cell frequency, a target cell identifier, and a multicast and broadcast services session configuration at the target cell. According to other example embodiments, the target network element information may include a dedicated random access channel resource. In some example embodiments, the target network element information may include one or more of a command to go to radio resource control idle state or inactive state, a multicast and broadcast services session configuration at the target cell, and a dedicated random access channel resource. In further example embodiments, the method may also include receiving a context release message from the target network element or an HO Success message from the target network element.

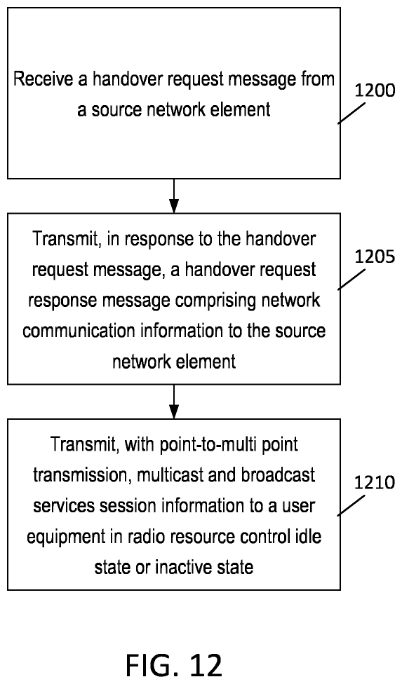

FIG. 12 illustrates an example of a flow diagram of another method, according to certain example embodiments. In an example embodiment, the method of FIG. 12 may be performed by a network entity, or a group of multiple network elements in a 3GPP system, such as LTE or 5G-NR. For instance, in an example embodiment, the method of FIG. 12 may be performed by a network or gNB similar to one of apparatuses 10 or 20 illustrated in FIG. 13.

According to certain example embodiments, the method of FIG. 12 may include, at 1200, receiving a handover request message from a source network element. The method may also include, at 1205, transmitting, in response to the handover request message, a handover request response message including network communication information to the source network element. The method may further include, at 1210, transmitting, with point-to-multi point transmission, multicast and broadcast services session information to a user equipment in radio resource control idle state or inactive state.

According to certain example embodiments, the method may also include transmitting a path switch request to a network element including information indicative of handover of the user equipment to idle state. According to other example embodiments, the method may also include transmitting a context release message to the source network element. According to other example embodiments, the method may also include transmitting a Handover Success message to the source network element. According to other example embodiments, the method may further include receiving, from the user equipment, transmission on a dedicated random access channel resource.

In certain example embodiments, the handover request message may include a flag indicating that the user equipment is receiving point-to-point and/or point-to-multipoint transmission of multicast and broadcast services session with in radio resource control connected state. In some example embodiments, the handover request response may be a handover request preparation failure message. In other example embodiments, the network communication information may include at least one of an indication that a multicast and broadcast services session in a target cell target is served using point-to-multipoint transmission to user equipment in a radio resource control idle state or inactive state, and a multicast and broadcast services session configuration. In further example embodiments, the handover request response may be a handover request acknowledgment message. In other example embodiments, the handover request acknowledgement message may include at least one of a command to a user equipment to go to a radio resource control idle state or inactive state, a multicast and broadcast services session configuration, and a dedicated random access channel resource. According to certain example embodiments, the handover request response may be a handover request preparation failure message. According to other example embodiments, the network communication information may include a command to a user equipment to go to a radio resource control idle state or inactive state, and a multicast and broadcast services configuration.

FIG. 13 illustrates a set of apparatus 10 and 20 according to certain example embodiments. In certain example embodiments, the apparatus 10 may be a node or element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 13.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 13.

As illustrated in the example of FIG. 13, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 13, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-10.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-10.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, while having an established radio resource control connection with a source network element, multicast and broadcast services session through a point-to-point transmission or point-to-multipoint transmission. Apparatus 10 may also be controlled by memory 14 and processor 12 to receive a radio resource control message indicating target network element information. Apparatus 10 may further be controlled by memory 14 and processor 12 to release a radio resource control connection and entering radio resource control idle state or inactive state in response to the radio resource control message. In addition, apparatus 10 may be controlled by memory 14 and processor 12 to select a target cell according to information received in the radio resource control message. Further, apparatus 10 may be controlled by memory 14 and processor 12 to perform radio communication with a target network element via the target cell. Additionally, apparatus 10 may be controlled by memory 14 and processor 12 to receive the multicast and broadcast services session in the target cell in inactive state or idle state.

As illustrated in the example of FIG. 13, apparatus 20 may be a network, core network element, or element in a communications network or associated with such a network, such as gNB. It should be noted that one of ordinary skill in the art would understand that apparatus 20 may include components or features not shown in FIG. 13.

As illustrated in the example of FIG. 13, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 13, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-9, 11, and 12.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-9, 11, and 12.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to transmit a handover request message to a target network element. Apparatus 20 may also be controlled by memory 24 and processor 22 to receive a handover request response message comprising network communication information. Apparatus 20 may further be controlled by memory 24 and processor 22 to transmit a radio resource control message to the user equipment indicating target network element information.

In other example embodiments, apparatus 20 may be controlled by memory 24 and processor 22 to receiving a handover request message from a source network element. Apparatus 20 may also be controlled by memory 24 and processor 22 to transmit, in response to the handover request message, a handover request response message comprising network communication information to the source network element. Apparatus 20 may further be controlled by memory 24 and processor 22 to transmit, with point-to-multi point transmission, multicast and broadcast services session information to a user equipment in radio resource control idle state or inactive state.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, while having an established radio resource control connection with a source network element, multicast and broadcast services session through a point-to-point transmission or point-to-multipoint transmission. The apparatus may also include means for receiving a radio resource control message indicating target network element information. The apparatus may further include means for releasing a radio resource control connection and entering radio resource control idle state or inactive state in response to the radio resource control message. In addition, the apparatus may include means for selecting a target cell according to information received in the radio resource control message. Further, the apparatus may include means for performing radio communication with a target network element via the target cell. Additionally, the apparatus may include means for receiving the multicast and broadcast services session in the target cell in inactive state or idle state.

Certain example embodiments may also be directed to an apparatus that includes means for transmitting a handover request message to a target network element. The apparatus may also include means for receiving a handover request response message comprising network communication information. The apparatus may further include means for transmitting a radio resource control message to the user equipment indicating target network element information.

Other example embodiments may be directed to an apparatus that includes means for receiving a handover request message from a source network element. The apparatus may also include means for transmitting, in response to the handover request message, a handover request response message comprising network communication information to the source network element. The apparatus may further include means transmitting, with point-to-multi point transmission, multicast and broadcast services session information to a user equipment in radio resource control idle state or inactive state.

Certain example embodiments described herein provide several technical improvements, enhancements, and/or advantages. For instance, in some example embodiments, the UE can directly move to IDLE/INACTIVE state without using any dedicated resources in the target cell resulting in reducing the control signaling overhead.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
BS Base Station
CHO Conditional Handover
DL Downlink
DM-1 Delivery Mode 1
DM-2 Delivery Mode 2
eNB Enhanced Node B
E-UTRAN Evolved UTRAN
gNB 5G or Next Generation NodeB
HO Handover
LTE Long Term Evolution
NR New Radio
PTM Point-to-multipoint
PTP Point-to-point
RLF Radio Link Failure
RS Reference Symbol
UE User Equipment
UL Uplink

1.-74. (canceled)

75. An apparatus, comprising:
at least one processor; and
at least one memory comprising computer program code,
the at least one memory and the computer program code are configured, with the at least one processor to cause the apparatus at least to:
receive, while having an established radio resource control connection with a source network element, multicast and broadcast services session through a point-to-point transmission or point-to-multipoint transmission;
receive a radio resource control message indicating target network element information;
release a radio resource control connection and entering radio resource control idle state or inactive state in response to the radio resource control message;
select a target cell according to information received in the radio resource control message;
perform radio communication with the target cell; and
receive the multicast and broadcast services session in the target cell in inactive state or idle state.

76. The apparatus according to claim 75, wherein the radio resource control message is a radio resource control reconfiguration message or a radio resource control release message.

77. The apparatus according to claim 75, wherein the target network element information comprises one or more of the following:
a target cell frequency,
a target cell identifier, and
a multicast and broadcast services session configuration at the target cell.

78. The apparatus according to claim 75, wherein the target network element information comprises an idle state command, and a multicast and broadcast services session configuration at the target cell.

79. The apparatus according to claim 75, wherein the target network element information further comprises a dedicated random access channel resource.

80. The apparatus according to claim 75, wherein the at least one memory and the computer program code are further configured, with the at least one processor to cause the apparatus at least to:
use the multicast and broadcast services session configuration to receive a point-to-multipoint transmission of multicast and broadcast services session in idle state or inactive state in the target cell.

81. An apparatus, comprising:
at least one processor; and
at least one memory comprising computer program code,
the at least one memory and the computer program code are configured, with the at least one processor to cause the apparatus at least to:
transmit a handover request message to a target network element;
receive a handover request response message comprising network communication information; and
transmit a radio resource control message to the user equipment indicating target network element information.

82. The apparatus according to claim 81, wherein the handover request message comprises a flag indicating that a user equipment is receiving point-to-point and/or point-to-multipoint transmission of a multicast and broadcast services session in a radio resource control connected state.

83. The apparatus according to claim 81,
wherein the handover request response is a handover request preparation failure message, and
wherein the network communication information comprises at least one of an indication that the multicast and broadcast services session in a target cell is served using point-to-multipoint transmission to user equipment in an idle or inactive delivery state, and a multicast and broadcast services session configuration; and
wherein the radio resource control message is a radio resource control release message.

84. The apparatus according to claim 81,
wherein the handover request response is a handover request acknowledgment message, and
wherein the handover request acknowledgement message comprises at least one of: a command to a user equipment to go to radio resource control idle state or inactive state,
a multicast and broadcast services session configuration, and
a dedicated random access channel resource, and
wherein the radio resource control message is a radio resource control reconfiguration message or a radio resource control release message.

85. The apparatus according to claim 81,
wherein the handover request response is an Xn Application Protocol handover request acknowledgement message, and
wherein the network communication information comprises:
a command to a user equipment to go to radio resource control idle state or inactive state, and
a multicast and broadcast services session configuration.

86. The apparatus according to claim 81, wherein the target network element information comprises:
a target cell frequency,
a target cell identifier, and
a multicast and broadcast services session configuration at the target cell.

87. The apparatus according to claim 81, wherein the target network element information comprises a dedicated random access channel resource.

88. The apparatus according to claim 81, wherein the target network element information comprises one or more of the following:
a command to go to radio resource control idle state or inactive state,
a multicast and broadcast services session configuration at the target cell, and
a dedicated random access channel resource.

89. The apparatus according to claim 81, wherein the at least one memory and the computer program code are further configured, with the at least one processor to cause the apparatus at least to:
receive a context release message from the target network element.

90. An apparatus, comprising:
at least one processor; and
at least one memory comprising computer program code,
the at least one memory and the computer program code are configured, with the at least one processor to cause the apparatus at least to
receive a handover request message from a source network element;
transmit, in response to the handover request message, a handover request response message comprising network communication information to the source network element; and
transmit, with point-to-multi point transmission, multicast and broadcast services session information to a user equipment in radio resource control idle state or inactive state.

91. The apparatus according to claim 90, wherein the at least one memory and the computer program code are further configured, with the at least one processor, to cause the apparatus at least to:
transmit a path switch request to a network element comprising information indicative of handover of the user equipment to idle state.

92. The apparatus according to claim 90, wherein the at least one memory and the computer program code are further configured, with the at least one processor to cause the apparatus at least to:
receive, from the user equipment, transmission on a dedicated random access channel resource.

93. The apparatus according to claim 90, wherein the handover request message comprises a flag indicating that the user equipment is receiving point-to-point and/or point-to-multipoint transmission of multicast and broadcast services session within radio resource control connected state.

94. The apparatus according to claim 90,
wherein the handover request response is a handover request preparation failure message, and
wherein the network communication information comprises at least one of an indication that a multicast and broadcast services session in a target cell target is served using point-to-multipoint transmission to user equipment in a radio resource control idle state or inactive state, and a multicast and broadcast services session configuration.
